(19) United States
(12) Patent Application Publication
(10) Pub. No.: US 2009/0284396 A1
(43) Pub. Date: Nov. 19, 2009

(54) SYSTEM FOR LOCATING VEHICLES IN PARKING LOTS AND METHOD THEREOF

(76) Inventors: Mohamed Rafeek, Valley Stream, NY (US); Bibi Khan, Valley Stream, NY (US)

Correspondence Address: JAY M. SCHLOFF, 6960 Orchard Lake Road, Suite 315, West Bloomfield, MI, 48322, US

(21) Appl. No.: 12/121,930

(22) Filed: May 16, 2008

(51) Int. Cl. G08G 1/123

(52) U.S. Cl. 340/991

(57) ABSTRACT

A system and a method for locating a vehicle are disclosed. The system includes a vehicle unit and a handheld unit. The vehicle unit is disposed in the vehicle. The vehicle unit is configured to generate a location signal representative of a location of the vehicle on receiving of an activation signal. The handheld unit includes a transceiver, a switch and a display unit. The transceiver is capable of communicating with the vehicle unit. The switch is configured to activate the transceiver to transmit the activation signal to the vehicle unit. The display unit is functionally coupled to the transceiver and is configured to display a direction of the vehicle relative to the handheld unit based on the location signal. The location signal is received from the vehicle unit by the transceiver.

### FIELD OF THE INVENTION

The present invention relates generally to systems for locating vehicles on streets or in parking lots, and, more particularly, to a system for identifying exact location of a vehicle with respect to a user of the vehicle.

### BACKGROUND OF THE INVENTION

Locating a vehicle parked in a parking space, in a garage, on a street, and in other similar places (hereinafter collectively referred to as “parking lot”) is often a difficult task. A user of the vehicle may require a considerable time to locate the vehicle. The process of locating the vehicle may get aggrieved when the user is accompanied by luggage or a child. In haste, the user may get confused between vehicles of similar manufacture or appearance. Thus the locating process of the vehicle may be frustrating, and depending on the time of day or the location, may even be dangerous.

Presently, there are many techniques that are normally practiced for locating a vehicle parked in the parking lot. Such techniques include noting and recalling positions of an object or landmark such as, marked area on a parking lot, posts, signs, trees, or buildings near the vehicle to locate the vehicle. Other techniques include a visual indication means disposed on the vehicle. The visual indication means may be extended above other parked vehicles so that the location of the vehicle may be easily seen.

Although, the existing techniques are designed for locating a vehicle parked in a parking lot, but these existing techniques have numerous limitations. For example, the user of the vehicle may forget the positions of objects or landmarks or may not be able to locate them. The visual indication means, as they extend above the other parked vehicles, are bulky and susceptible to being damaged. Moreover, the existing systems and methods for locating a vehicle parked in a parking lot are not effective or efficient solutions.

Accordingly, based on the foregoing, there is a need for a reliable, simple and easy to use system for locating a vehicle parked in a parking lot. Furthermore, the system should be able to provide location of the vehicle relative to a user of the vehicle.

### SUMMARY OF THE INVENTION

In view of the foregoing disadvantages inherent in the prior art, the general purpose of the present invention is to provide a system for locating a vehicle parked in a parking lot configured to include all the advantages of the prior art, and to overcome the drawbacks inherent therein.

Accordingly, an object of the present invention is to provide a system, which is capable of indicating a direction of a vehicle relative to a user of the vehicle.

Another object of the present invention is to provide a system for locating a vehicle, which is capable of being carried by a user with ease and is simple to use.

In light of the above objects, in one aspect of the present invention, a system for locating a vehicle is disclosed. The system includes a vehicle unit and a handheld unit. The vehicle unit is disposed in the vehicle. The vehicle unit is configured to generate a location signal representative of a location of the vehicle on receiving of an activation signal. The handheld unit includes a transceiver, a switch and a display unit. The transceiver is capable of communicating with the vehicle unit. The switch is configured to activate the transceiver to transmit the activation signal to the vehicle unit. The display unit is functionally coupled to the transceiver and is configured to display a direction of the vehicle relative to the handheld unit based on the location signal. The location signal is received from the vehicle unit by the transceiver.

In another aspect of the present invention, a method for locating a vehicle is disclosed. The method includes transmitting an activation signal to a vehicle unit from a handheld unit. The vehicle unit is disposed in the vehicle. Further, the method includes receiving a location signal in response to the activation signal at the handheld unit from the vehicle unit. Thereafter, the method includes displaying a direction of the vehicle relative to the handheld unit in response to the location signal received at the handheld unit.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, in which:

FIG. 1 illustrates a schematic view of use of a system for locating a vehicle, in accordance with an embodiment of the present invention;

FIG. 2A illustrates a schematic block diagram of a handheld unit of the system, in accordance with an embodiment of the present invention;

FIG. 2B illustrates a perspective view of the handheld unit of FIG. 2A, in accordance with an embodiment of the present invention; and

FIG. 3 illustrates a flow diagram depicting a method for locating the vehicle, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular system or method for locating a vehicle, as shown and described. It is understood that various omissions and substitutions of equivalents are contemplated as circumstances may suggest or render expedient, but these are intended to cover the application or implementation without departing from the spirit or scope of the claims of the present invention.

The terms “a” and “an” herein do not denote a limitation of quantity, but rather denote the presence of at least one of the referenced item.

The present invention provides a system and a method for locating a vehicle. The system includes a vehicle unit and a handheld unit. The vehicle unit is disposed in the vehicle. The vehicle unit is configured to generate a location signal representative of a location of the vehicle on receiving of an activation signal. The handheld unit includes a transceiver, a switch and a display unit. The transceiver is capable of communicating with the vehicle unit. The switch is configured to activate the transceiver to transmit the activation signal to the vehicle unit. The display unit is functionally coupled to the transceiver. The display unit is configured to display a direction of the vehicle relative to the handheld unit based on the location signal, where the location signal is received by the transceiver from the vehicle unit.

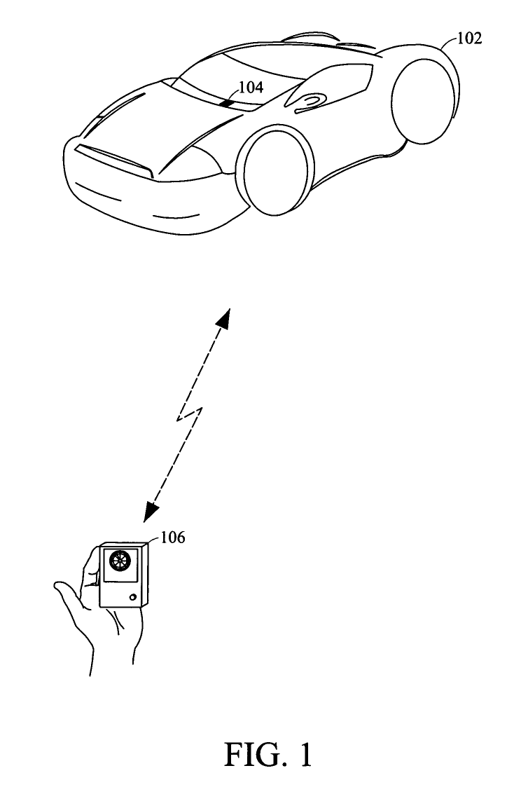

Referring to FIG. 1, a system for locating a vehicle 102 is illustrated. The vehicle 102 may be located on a street, in a parking lot, in a garage, and on a similar place (collectively referred to as ‘parking lot’). The system includes a vehicle unit 104 and a handheld unit 106. The vehicle unit 104 and the handheld unit 106 are capable of communicating with each other for facilitating a user of the vehicle 102 to locate a position of the vehicle 102 with respect to the user.

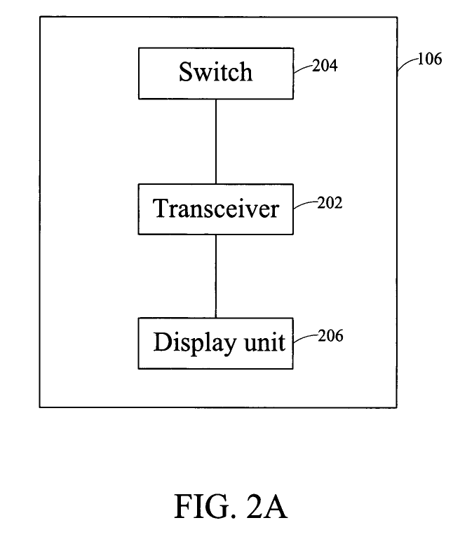

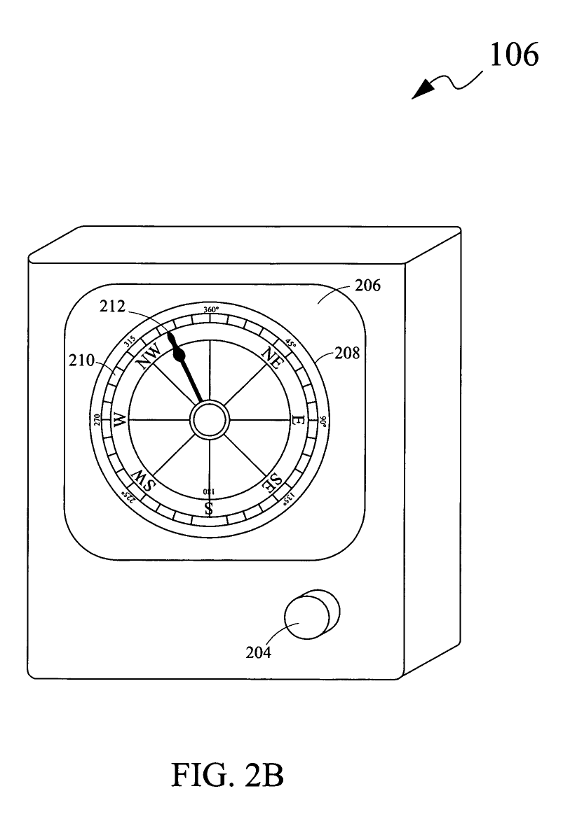

The vehicle unit 104 is disposed at a suitable position in the vehicle 102. For example, as shown in FIG. 1, the vehicle unit 104 is disposed on a dashboard (not represented) of the vehicle 102. However, it will be evident to a person skilled in the art that the vehicle unit 104 may be disposed in other locations in the vehicle 102, which facilitates effective communication with the handheld unit 106. The vehicle unit 104 is configured to generate a location signal representative of a location of the vehicle 102 on receiving of an activation signal from the handheld unit 106. The handheld unit 106 may be carried by the user of the vehicle 102. The handheld unit 106 receives the location signal from the vehicle unit 104 and the direction of the vehicle 102 is displayed in the handheld unit 106. The handheld unit 106 is further described in details in conjunction with FIGS. 2A and 2B.

Referring to FIG. 2A, a schematic block diagram of the handheld unit 106 is shown. The handheld unit 106 is configured to be carried with ease, for example, in a purse, a hand, or a pocket of the user. The handheld unit 106 includes a transceiver 202, a switch 204 and a display unit 206. In one embodiment of the present invention, the handheld unit 106 may further include a microprocessor as a processing unit.

The handheld unit 106 communicates with the vehicle unit 104 through the transceiver 202. The transceiver 202 is configured to transmit the activation signal to the vehicle unit 104. The transceiver 202 is also configured to receive the location signal transmitted by the vehicle unit 104, which is transmitted by the vehicle unit 104 in response to the activation signal. In one embodiment of the present invention, the transceiver 202 is a Global Positioning System (GPS) transceiver. In this embodiment, the transceiver 202 is configured to receive the location signal that is a GPS based signal including location information of the vehicle unit 104. Further, the handheld unit 106 displays the direction of the vehicle 102 based on the GPS based signal.

It will be apparent to a person skilled in the art that the system of the present invention may utilize other techniques for determining the direction of the vehicle 102 with respect to the user, i.e., the handheld unit 106. The handheld unit 106 may receive location information of the handheld unit 106 and location information of the vehicle unit 104 from a GPS based control point. The GPS based control point may have information about locations of the vehicle unit 104 and the handheld unit 106. The handheld unit 106 may therefore compare the location information of the handheld unit 106 with the location information of the vehicle unit 104, to determine the location of the vehicle 102, i.e., the vehicle unit 104 with respect to the handheld unit 106.

The user may activate the transceiver 202 to transmit the activation signal in order to get the location of the vehicle 102 by operating the switch 204. The switch 204 may be a pressure activated push button switch, a knob, a dial, and the like, and is functionally coupled to the transceiver 202. When the user operates the switch 204, the transceiver 202 is configured to generate the activation signal, which may be received by the vehicle unit 104. The vehicle unit 104 thereafter provides the location signal representative of the location of the vehicle 102 to the transceiver 202. The transceiver 202 receives the location signal. The display unit 206 being functionally coupled to the transceiver 202 is configured to display the direction of the vehicle 102 relative to the handheld unit 106 based on the location signal. The display unit 206 may be an electronic display system or a mechanical display system The display unit 206 having the mechanical display system is shown in FIG. 2B.

A perspective view of the handheld unit 106 is represented in FIG. 2B, in accordance with an exemplary embodiment of the present invention. More specifically, the perspective view of the handheld unit 106 includes the switch 204 and the display unit 206. The switch 204 is represented as a push button in this exemplary embodiment of the present invention. The display unit 206 includes a direction indicator 208 for displaying the direction of the vehicle 102 with respect to the handheld unit 106. The direction indicator 208 may be an analog indicator or a digital indicator. In this exemplary embodiment, the direction indicator 208 includes a dial 210 and a pointer 212.

As shown in FIG. 2B, the dial 210 includes directions printed on a periphery of the dial 210 such as, North (N), South (S), East (E), West (W), North East (NE), South East (SE), South West (SW) and North West (NW), similar to a magnetic compass. Additionally, the dial 210 also includes subsections between the directions of the dial 210 to provide a precise location of the vehicle 102 with respect to the handheld unit 106. The pointer 212 is configured to indicate the location of the vehicle 102 with respect to the handheld unit 106 by resting at a particular subsection of the dial 210 (not represented) of the direction indicator 208.

In one embodiment of the present invention, the vehicle unit 104 may includes components necessary for the communication with the handheld unit 106 of the system. In one embodiment of the present invention, the vehicle unit 104 may include a transmitter (not shown). The transmitter may be configured to transmit the location signal representative of the location of the vehicle 102 on receiving of the activation signal. In another embodiment of the present invention, the vehicle unit 104 may include a transceiver (not shown). In yet another embodiment of the present invention, the vehicle unit 104 may include a Global Positioning System (GPS) transceiver (not shown). The GPS transceiver is configured to receive a GPS data regarding location information of the vehicle 102. The GPS transceiver is also configured to transmit the GPS data regarding the location information of the vehicle 102 to the handheld unit 106 upon activation from the activation signal generated by the handheld unit 106.

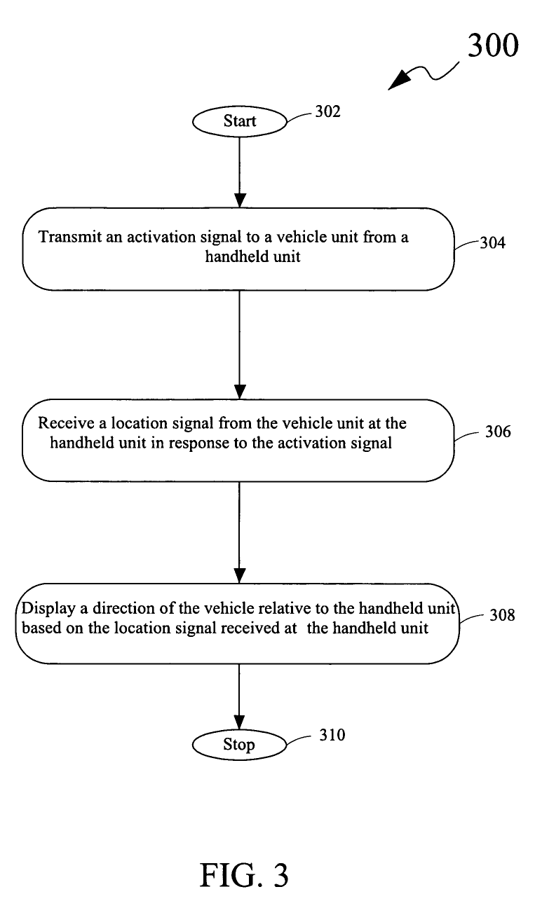

Further referring to the FIG. 3, a flow diagram depicting a method 300 for locating a vehicle, such as a vehicle 102, is illustrated. The method 300 begins by actuation of a switch, such as the switch 204 of a handheld unit, such as the handheld unit 106, at 302. At 304, an activation signal is transmitted to a vehicle unit, such as the vehicle unit 104, from the handheld unit. Specifically, the activation signal is transmitted to the vehicle unit in response to the actuation of the switch of the handheld unit. Further, at 306, a location signal is received from the vehicle unit at the handheld unit in response to the activation signal. In one embodiment of the present invention, the location signal includes a GPS data including location information of the vehicle. Thereafter, at step 308, a direction of the vehicle relative to the handheld unit is displayed based on the location signal received at the handheld unit. Thereafter, at 310, the method 300 terminates. In one embodiment of the present invention, the direction of the vehicle relative to the handheld unit is displayed after receiving and comparing a GPS data regarding the location information of the handheld unit with the GPS data regarding the location information of the vehicle.

Various embodiments of the present invention offer following advantages. The system and the method of the present invention are capable of providing a location of a vehicle to the user of the vehicle by providing a direction of the vehicle relative to a handheld unit carried by the user. Further, the system of the present invention is simple and easy to use by the user. Furthermore, the system of the present invention may be carried by the user with ease. Moreover, the use of the system of the present invention also saves time while locating the vehicle in a crowded parking lot.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A system for locating a vehicle, the system comprising:
a vehicle unit disposed in the vehicle, the vehicle unit configured to generate a location signal representative of a location of the vehicle on receiving of an activation signal; and
a handheld unit comprising,
a transceiver capable of communicating with the vehicle unit,
a switch configured to activate the transceiver to transmit the activation signal to the vehicle unit, and
a display unit functionally coupled to the transceiver, the display unit configured to display a direction of the vehicle relative to the handheld unit based on the location signal, wherein the location signal is received from the vehicle unit by the transceiver.

2. The system of claim 1, wherein the display unit comprises a direction indicator for displaying the direction of the vehicle relative to the handheld unit.

3. The system of claim 1, wherein the transceiver is a Global Positioning System (GPS) transceiver.

4. A method for locating a vehicle, the method comprising:
transmitting an activation signal to a vehicle unit from a handheld unit, the vehicle unit disposed in the vehicle;
receiving a location signal from the vehicle unit at the handheld unit in response to the activation signal; and
displaying a direction of the vehicle relative to the handheld unit based on the location signal received at the handheld unit.

5. The method of claim 4, wherein receiving the location signal comprises receiving a Global Positioning System (GPS) based signal.
